(19) United States
(12) Patent Application Publication
(10) Pub. No.: US 2014/0165332 A1
(43) Pub. Date: Jun. 19, 2014

(54) PIVOT SHOWER DOOR ASSEMBLY

(71) Applicant: Foshan Ideal Co. Ltd., Gaoming (CN)

(72) Inventor: Wuxiang Wei, Foshan (CN)

(73) Assignee: Foshan Ideal Co., Ltd., Foshan (CN)

(21) Appl. No.: 13/780,604

(22) Filed: Feb. 28, 2013

(30) Foreign Application Priority Data
Dec. 13, 2012 (CN) 201220687521.5

(51) Int. Cl. E05D 7/10

(52) U.S. Cl. CPC E05D 7/1061
USPC 16/271

(57) ABSTRACT

A pivot shower door assembly is provided comprising a stationary frame having a guiding groove extending longitudinally along the stationary frame; sliders slidably mounted in the guiding groove, including an upper slider and a lower slider disposed at respective end of the guiding groove, each of the sliders having a first engaging element; and a movable frame having detachable seats, including an upper seat and a lower seat, each of the seats having a second engaging element and a spindle for connecting with a pivot door, wherein when a relative position of the stationary frame and the movable frame is determined, the first engaging element of the upper slider is engaged with the second engaging element of the upper seat and the first engaging element of the lower slider is engaged with the second engaging element of the lower seat.

### CROSS REFERENCE TO RELATED DOCUMENT

The present invention claims priority from Chinese utility model application No. 201220687521.5 filed on Dec. 13, 2012, the disclosure of which is hereby incorporated herein by reference.

### FIELD OF THE INVENTION

The present invention relates to a pivot shower door and, in particular, to a fast mounting structure used for pivot shower doors.

### BACKGROUND OF THE INVENTION

Conventional pivot doors, such as pivot shower doors, comprise a stationary frame for fixing to a wall and a movable frame that is capable of adjusting its position in relative to the stationary frame such that both frames are properly engagement with each other. In order to engage both frames, the frames have to be aligned and drilled and fasteners are used to pass through the drilled holes and fasten the frames together. The assembly method of this kind is inconvenient to operation and quite time consuming. In addition, the drilling operation can possibly make damage to the materials made of the frames, for example aluminum materials. This may affect the appearance and service life of the door, or even cause the door unusable.

### SUMMARY OF THE INVENTION

An object of the invention is to achieve fast mounting of pivot door while avoiding damages to the materials made of the frames.

To achieve this, a pivot shower door assembly is provided comprising a stationary frame having a guiding groove extending longitudinally along the stationary frame; sliders slidably mounted in the guiding groove, including an upper slider and a lower slider mounted at respective end of the guiding groove, each of the sliders having a first engaging element; and an movable frame having detachable seats, including an upper seat and a lower seat, each of the seats having a second engaging element and a spindle for engaging a pivot door, wherein when a relative position between the stationary frame and the movable frame is determined, the first engaging element of the upper slider is engaged with the second engaging element of the upper seat, and the first engaging element of the lower slider is engaged with the second engaging element of the lower seat.

In one embodiment, when the relative position between the stationary frame and the movable frame is determined, both sidewalls of the stationary frame are inserted into a space defined by the movable frame. In this embodiment, a corresponding slot is provided to each of the seats for passing through of each of the both sidewalls.

In another embodiment, when the relative position between the stationary frame and the movable frame is determined, both sidewalls of the stationary frame are located outside the movable frame. In this embodiment, none of the seats is provided with a slot.

In order to avoid position shift after the relative position between the stationary frame and the movable frame is determined, the upper slider is secured to the upper seat through fasteners. In one example, a long hole is provided on a surface of the upper slider where the first engaging element is located and a through hole is provide on a surface of the upper seat where the second engaging element is located. The fasteners pass through the long hole and the through hole to secure the upper slider and the upper seat together, in order to avoid relative movement.

Although the lower seat and slider can also be secured together in the same way, it is not necessary to do so, because they are naturally tightly connected due to gravity force of the frames. However, in consideration of the unity of components, the lower seat and slider can also be thus secured.

In one embodiment, a recess is provided to each of the seats, and the second engaging element is arranged on a bottom surface of the recess. A part of the slider is accommodated in the recess, such that top surfaces of the sliders are flushed with top surfaces of the seats.

The stationary frame is generally fixed to a wall surface. In one embodiment, the stationary frame has at least one hole for fixing the stationary frame to the wall surface through screws. In other embodiment, the stationary frame is fixed to a wall surface through in other suitable manner, for example, by adhesives.

In one embodiment, each of the sliders has two parts located in two perpendicular planes, wherein a first part has a flange for inserting into the guiding groove of the stationary frame and a second part has an inner surface on which the first engaging element is arranged. As stated above, the second part is preferably provided with the long hole.

In one embodiment, the first and second engaging elements are teeth with same or inverse directions.

In the present invention, the seat is detachable from the stationary frame, which can be achieved in different ways. For example, the seats may be provided with for example two holes and corresponding holes are provided on the movable frame, such that the seats and the movable frame are connected by screws. When it is necessary to detach the seats from the stationary frame, it can be done by simply release the screws by using suitable tools.

In operation, the relative position of the lower slider and lower seat is determined first such that the first engaging element of the lower slider and the second engaging element of the lower seat are engaged together to avoid relative movement between the lower slider and seat. Then the relative position of the upper slider and upper seat is determined such that the first engaging element of the upper slider and the second engaging element of the upper seat are engaged together to avoid relative movement between the upper slider and seat. In this way, the position of the movable frames in relation to the stationary frame is finally determined, and followed by mounting of the pivot door. Preferably, the upper slider and upper seat is secured by fasteners after the position of the movable frame is determined.

When it is necessary to adjust the position of the movable frame in relation to the stationary frame, it can be achieved by changing the relative engaging position between the first and second engaging elements of the sliders and seats. In the case that the upper slider is secured with the upper seat through fasteners, the fasteners should be released and then the changing of the relative engaging position is carried out.

The present invention has relatively simple structure and is convenient for assembly. In particular, it does not need to be drilled such that the risk of damage is minimized. In addition, a fast assembling method can thus be obtained that has simplified steps and takes less time.

### BRIEF DESCRIPTION OF THE DRAWINGS

Further advantages and details of the present invention emerge from the example embodiments described below, which do not limit the invention in any way, and from the drawings, in which

FIG. 1 is an exploded view of a pivot shower door assembly according to one example of the present invention;

FIG. 2 is an enlarged view of a part of the stationary frame according to one example of the present invention;

FIG. 3 is another view of the stationary frame shown in FIG. 2;

FIG. 4 a perspective view of an upper slider according to one example of the present invention;

FIG. 5 is another view of the upper slider shown in FIG. 4;

FIG. 6 is a perspective view of an upper seat according to one example of the present invention;

FIG. 7 is another view of the upper seat shown in FIG. 6;

FIG. 8 is an enlarged view of a part of the movable frame according to one example of the present invention;

FIG. 9 is a perspective view of a lower slider according to one example of the present invention;

FIG. 10 is another view of the lower slider shown in FIG. 9;

FIG. 11 a perspective view of a lower seat according to one example of the present invention;

FIG. 12 is another view of the lower seat shown in FIG. 11;

FIG. 13 a perspective view of an upper seat according to another example of the present invention;

FIG. 14 is another view of the upper seat shown in FIG. 13;

FIG. 15 a perspective view of a lower seat according to another example of the present invention;

FIG. 16 is another view of the lower seat shown in FIG. 15.

Elements that are irrelevant to the spirit of the present invention are omitted for clarity.

### DETAILED DESCRIPTION OF THE INVENTION

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” include any and all combinations of one or more of the associated listed items. It will be further understood that the terms “comprises” “comprising” “includes” and/or “including” when used herein, specify the presence of stated features, integers, steps, operations, elements, and/or components, but do not preclude the presence or addition of one or more other features, integers, steps, operations, elements, components, and/or groups thereof.

### Example 1

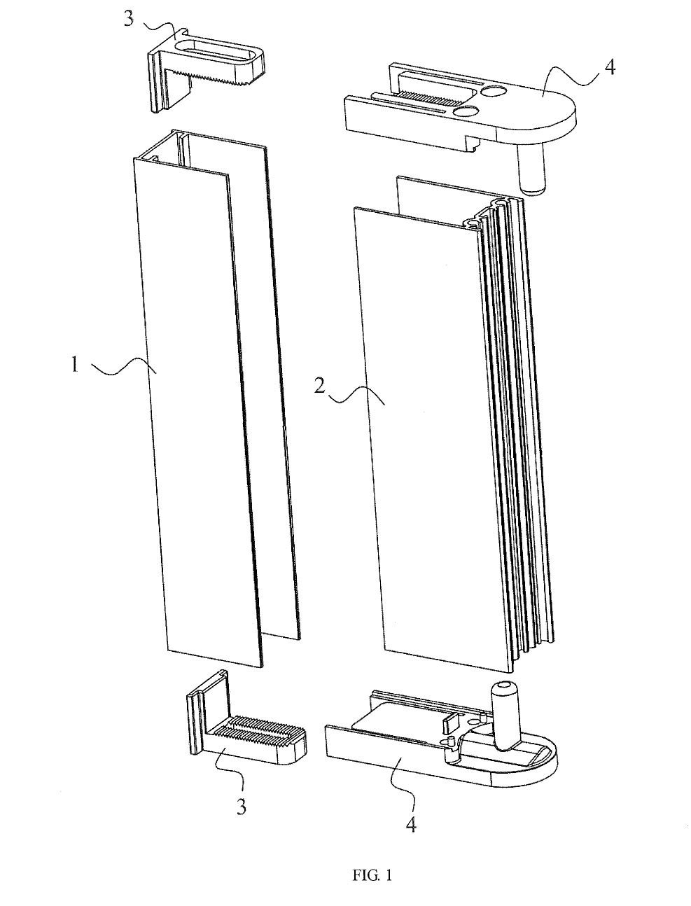

With reference to FIG. 1, a pivot door assembly is provided comprising a stationary frame 1, a movable frame 2, sliders 3 and seats 4. In this example, the pivot door assembly is provided with two sliders 3 located at respective end of the stationary frame 1. The pivot door assembly also has two seats 4, located at respective end of the movable frame 2. In the present invention, the slider and seat that are located at top end of the stationary frame 1 are called “upper slider” and “upper seat”, and the slider and seat that are located at bottom end of the stationary frame 1 are called “lower slider” and “lower seat”.

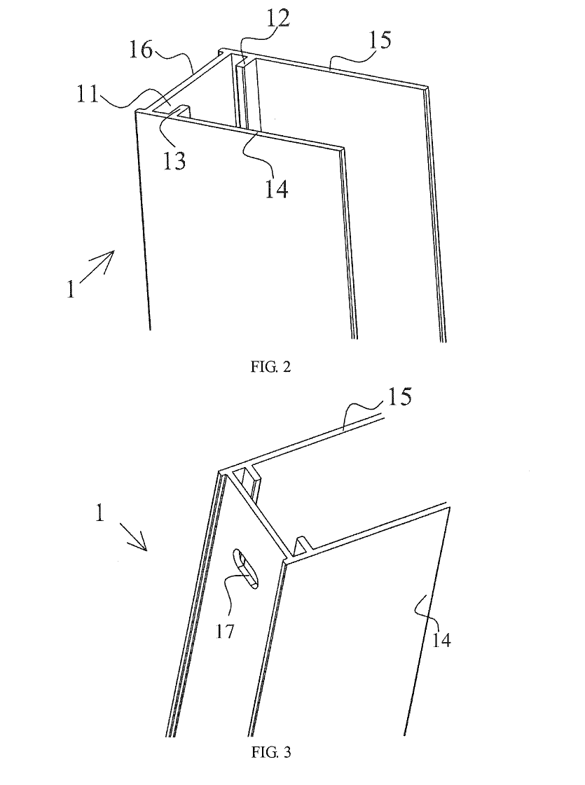

Referring to FIGS. 2 to 3, the stationary frame 1 consists of a base 16, sidewalls 14 and 15. A first baffle 13 is provided to the sidewall 14, and a second baffle 12 is provided to the sidewall 15. The baffles 12, 13 and the base 16 define a guiding groove 11. The sliders 3 can be disposed in the guiding groove 11 and capable of sliding freely. In this example, as can be seen from FIG. 3, at least one hole 17 is provided to the base 16 of the stationary frame 1 for conveniently fixing the stationary frame 1 to a surface such as a wall surface through fasteners, e.g., screws. The structures of the sliders 3 will be described in detail hereinafter.

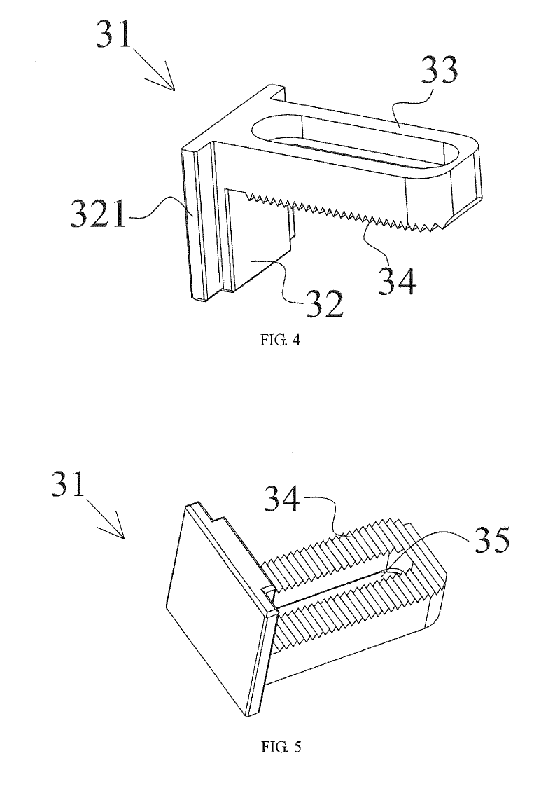

With reference to FIGS. 4 to 5, an upper slider 31 is shown in detail. The upper slider 31 is in the form of a letter “L” and has a first part 32 and a second part 33 which is substantially perpendicular to the first part 32. A flange 321 is formed at two sides of the first part 32, which is used for inserting into the guiding groove 11; thereby the slider is slidable therein. A first tooth 34 is provided on the second part 33 on a surface facing downward. The tooth 34 is arranged throughout the whole surface, facing towards a same direction. In this example, a long hole 35 is provided on the second part 33 for connecting the upper slider and the upper seat, which will be described in detail in the following.

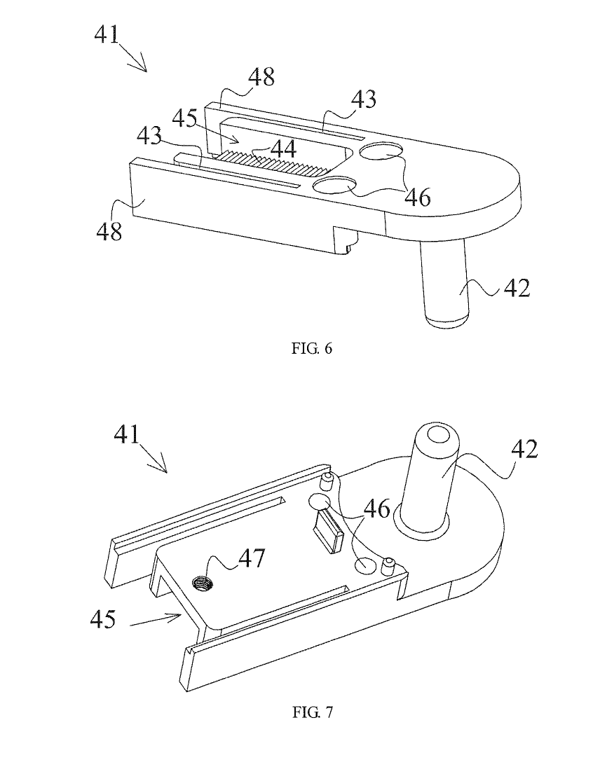

With reference to FIGS. 6 and 7, an upper seat 41 is shown in detail. The upper seat 41 has a spindle 42 at one side for connection with a pivot door and a recess 45 at opposite side. On the bottom surface of the recess 45 is distributed with a second tooth 44. The second tooth 44 is arranged throughout the whole surface and faced towards a same direction. The upper seat 41 further comprises a slot 43 located between the recess 45 and a sidewall 48, for passing through of the sidewalls 14, 15 of the stationary frame 1. The upper seat 41 is detachably connected with the movable frame 2. In this example, the upper seat 41 is connected with the movable frame 2 by providing a hole 46 on the upper seat 41 and a hole 23 (see FIG. 8) on the movable frame 2.

In operation, the stationary frame 1 is firstly fixed to a wall surface, followed by moving the movable frame 2 towards the stationary frame 1. In this example, the sidewalls 14 and 15 are spaced at a distance smaller than sidewalls 21, 22 (see FIG. 8) of the movable frame. In this case, when the movable frame 2 is moved towards the stationary frame 1, the sidewalls 14, 15 will be inserted into a space defined by the sidewalls 21, 22 of the movable frame 2 and consequently into the slot 43 of the upper seat 41.

When the relative position between the stationary frame 1 and the movable frame 2 is determined, the second part 33 of the upper slider 31 is received within the recess 45 of the upper seat 41, and the first tooth 34 of the upper slider 31 is engaged with the second tooth 44 of the upper seat 41, so as to determine the upper position of the movable frame 2.

The upper seat 41 further comprises a hole 47 at the recess 45. A screw is used to pass through the long hole 35 of the upper slider 31 and the hole 47 of the upper seat 41 to connect the upper slider 31 and the upper seat 41, in order to ensure that the top portion of the movable frame 2 will not move in relation to the stationary frame 1.

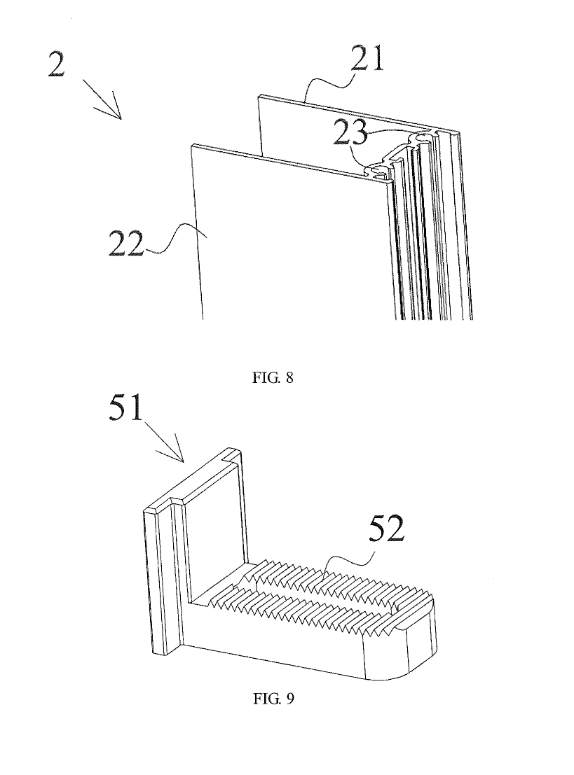

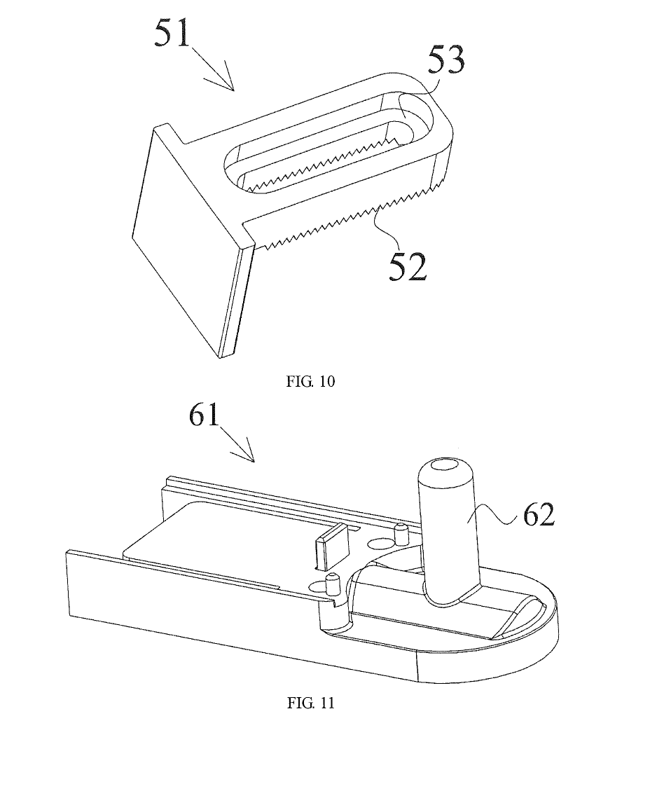

With reference to FIGS. 9 and 10, a lower slider 51 is shown in detail. In this example, the lower slider 51 has similar structure as the upper slider 31, in which a first tooth 52 and a long hole 53 are provided. The long hole 53 can also be absent from the lower slider 51.

Referring to FIGS. 11 and 12, a lower seat 61 is shown in detail. In this example, the lower seat 61 has similar structure as the upper seat 41, in which a spindle 62, a recess 65 and a second tooth 64 are provided, except that the lower seat 61 has no hole.

The spindles 62 and 42 are arranged opposite to each other, through which a pivot door is connected to the movable frame 2 and rotatable about the spindles. A part of the lower slider 51 can be received within the recess and the first tooth 52 is engaged with the second tooth 64 so as to determine the position of the lower part of the movable frame 2. Due to the gravity force of the stationary and movable frames, the first tooth 52 and the second tooth 64 will engaged tightly without need of additional securing measures, to ensure that the lower part of the movable frame does not move in relation to the stationary frame.

When the position of the upper and lower part of the movable frame 2 in relation to the stationary frame is determined, the relative position between the movable frame 2 and the stationary frame 1 will be determined. When the relative position needs to be changed or adjusted, the fastener on the upper slider 31 is released, followed by the adjustment of the relative position between the first tooth and the second tooth, such that the relative position of the stationary and movable frames are adjusted.

### Example 2

This example is substantively same as the Example 1, except that the sidewalls 14, 15 of the stationary frame 1 are spaced at a distance larger than that of the sidewalls 21, 22, so that when the movable frame 2 is moved towards the stationary frame 1, the sidewalls 21, 22 would be inserted in to the space defined by the sidewalls of the stationary frame 1.

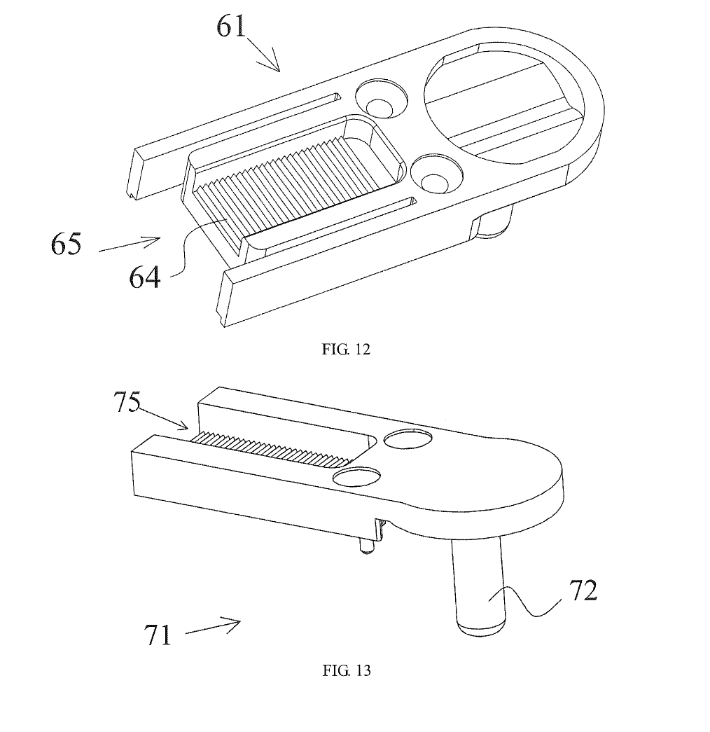

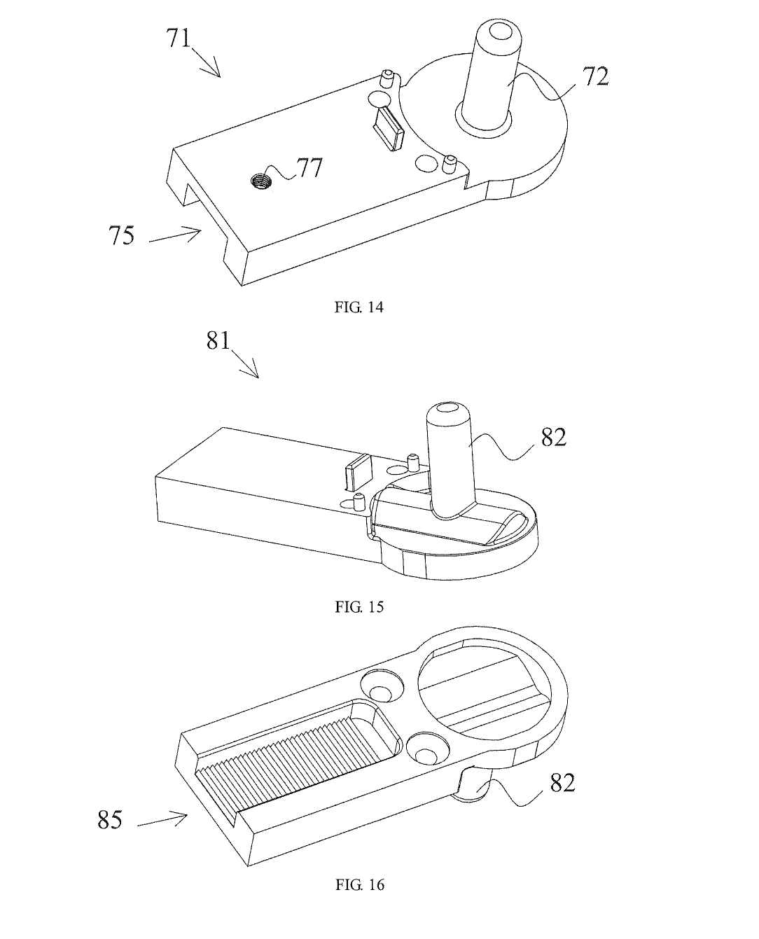

Therefore, in this example, no slot, as stated above, for passing through of the sidewalls 14, 15 of the stationary frame 1 is provided to the upper and lower seats. FIGS. 13 and 14 show the detailed structures of the upper seat 71 in this example. The upper seat 71 has a spindle 72 and a recess 75. On the bottom surface of the recess 75 is provided with a hole 77. FIGS. 15 to 16 show the detailed structures of the lower seat 82 in this example. The lower seat 82 has a spindle 82 and a recess 85.

It should be understood that various example embodiments have been described with reference to the accompanying drawings in which only some example embodiments are shown. The present invention, however, may be embodied in many alternate forms and should not be construed as limited to only the example embodiments set forth herein.

What is claimed is:

1. A pivot shower door assembly, comprising
a stationary frame having a guiding groove extending longitudinally along the stationary frame;
sliders slidably mounted in the guiding groove, including an upper slider and a lower slider disposed at respective end of the guiding groove, each of the sliders having a first engaging element; and
a movable frame having detachable seats, including an upper seat and a lower seat, each of the seats having a second engaging element and a spindle for connecting with a pivot door, wherein
when a relative position of the stationary frame and the movable frame is determined, the first engaging element of the upper slider is engaged with the second engaging element of the upper seat and the first engaging element of the lower slider is engaged with the second engaging element of the lower seat.

2. The pivot shower door assembly according to claim 1, wherein when the relative position of the stationary frame and the movable frame is determined, two sidewalls of the stationary frame is inserted into a space defined by the movable frame.

3. The pivot shower door assembly according to claim 2, wherein each of the seats has slots for passing through of the two sidewalls of the stationary frame.

4. The pivot shower door assembly according to claim 1, wherein the upper slider and the upper seat is secured together through fasteners.

5. The pivot shower door assembly according to claim 4, wherein a long hole is provided on a surface of the upper slider where the first engaging element is located and a through hole is provide on a surface of the upper seat where the second engaging element is located, the fasteners passing through the long hole and the through hole to secure the upper slider and the upper seat together.

6. The pivot shower door assembly according to claim 1, wherein each of the seats has a recess, the second engaging element being arranged on a bottom surface of the recess, and a part of each of the sliders being received in the recess, such that top surfaces of the sliders are flushed with top surfaces of the seats.

7. The pivot shower door assembly according to claim 1, wherein the stationary frame is fixed to a wall surface.

8. The pivot shower door assembly according to claim 1, wherein each of the sliders has a first part and a second part located in perpendicular planes, and wherein the first part has a flange for inserting into the guiding groove of the stationary frame, and the second part has an inner surface provided with the first engaging element.

9. The pivot shower door assembly according to claim 1, wherein each of the seats has a first hole and the movable frame has a second hole at each end, the seats being connected with the movable frame by screws passing through the first and second holes.
